(19) United States
(12) Patent Application Publication
(10) Pub. No.: US 2013/0305296 A1
(43) Pub. Date: Nov. 14, 2013

(54) IN-HOME EQUIPMENT, CONTENT HANDOFF METHOD, AND CONTENT HANDOFF PROGRAM

(71) Applicants: Izuru Hashimura, Shizuoka (JP); Masaki Sakata, Sapporo-shi (JP)

(72) Inventors: Izuru Hashimura, Shizuoka (JP); Masaki Sakata, Sapporo-shi (JP)

(73) Assignees: NEC SOFTWARE HOKKAIDO, LTD., Sapporo-shi, Hokkaido (JP); NEC ACCESS TECHNICA, LTD., Kakegawa-shi, Shizuoka (JP)

(21) Appl. No.: 13/881,296

(22) PCT Filed: Dec. 15, 2011
(86) PCT No.: PCT/JP2011/007010

§ 371 Date: Jul. 31, 2013

(30) Foreign Application Priority Data
Dec. 20, 2010 (JP) 2010-283488

(51) Int. Cl. H04N 21/637

(52) U.S. Cl. CPC H04N 21/637
USPC 725/74

(57) ABSTRACT

The in-home equipment comprises: playback availability determining means 11 which, in the case of generation of a playback request for playing back a content on any of the plurality of playback devices, determines whether the playback device requested to play back the content is able to play back the content; and playback instructing means 12 which, in the case where the playback availability determining means 11 determines that the playback device is able to play back the content, causes the playback device to play back the content, wherein, in the case of generation of a handoff request to playback process by the playback device playing back the content to other playback device, the playback availability determining means 11 determines whether the other playback device is able to play back the content, and the in-home equipment further comprises handoff control means 13 which stops the playback of the content and causes the other playback device to play back the content from a handoff position in the case where the playback availability determining means 11 determines that the other playback device is able to play back the content.

### TECHNICAL FIELD

The present invention relates to an in-home equipment having a content inheritance control function, a content handoff method, and a content handoff program.

### BACKGROUND ART

Due to the generalization of the high-speed Internet and large-capacity recording devices, it is possible to playback a large-scale media content on the Internet and media contents accumulated by a user by a variety of renderers and in a variety of playback environments. Likewise, due to the popularization of mobile devices, it is general to consume these contents while moving. Consequently, it is required to provide a content playback method capable of freely changing a renderer with the existing playback environment maintained. As one of content playback methods, there is a method of handoff a renderer with the playback environment maintained (for example, refer to Patent Literature (PTL) 1). Moreover, there is a method in which a first renderer generates inheritance data including playback position handoff time information and the like and sends the inheritance data to a second renderer via a network by which the content playback is handed off between the renderers (for example, refer to Patent Literature (PTL) 2).

### CITATION LIST

### Patent Literature(s)

PTL 1: Japanese Patent Application Laid-Open No. 2007-174642
NPL 2: Japanese Patent Application Laid-Open No. 2007-300391

### SUMMARY OF INVENTION

### Technical Problem

In the methods described in PTL 1 and PTL 2, the content playback is able to be inherited only between renderers equipped with a unique function. Therefore, in the case of no renderer equipped with the unique function, it is impossible to inherit the content playback.

Therefore, the present invention provides an in-home equipment capable of inheriting content playback at low cost by using existing renderers, a content handoff method, and a content handoff program.

### Solution to Problem

According to the present invention, there is provided an in-home equipment which is connectable to one or a plurality of servers and a plurality of playback devices, comprising: playback availability determining means which, in the case of generation of a playback request for playing back a content on any of the plurality of playback devices, determines whether the playback device requested to playback the content is able to play back the content; and playback instructing means which, in the case where the playback availability determining means determines that the playback device is able to play back the content, causes the playback device to play back the content, wherein, in the case of generation of a handoff request to hand off playback process by the playback device playing back the content to other playback device, the playback availability determining means determines whether the other playback device is able to play back the content, and the in-home equipment further comprises handoff control means which stops the playback of the content and causes the other playback device to play back the content from a handoff position in the case where the playback availability determining means determines that the other playback device is able to play back the content.

According to the present invention, there is provided a content handoff method in a in-home equipment which is connectable to one or a plurality of servers and a plurality of playback devices, including the steps of: in the case of generation of a playback request for playing back a content on any of the plurality of playback devices, determining whether the playback device requested to playback the content is able to play back the content; in the case where it is determined that the playback device is able to play back the content, causing the playback device to play back the content; in the case of generation of a handoff request to hand off playback process by the playback device playing back to other playback device, determining whether the other playback device is able to play back the content; and in the case where it is determined that the other playback device is able to play back the content, stopping the playback of the content and causing the other playback device to play back the content from a handoff position.

According to the present invention, there is provided a content handoff program in in-home equipment which is connectable to one or a plurality of servers and a plurality of playback devices, the program causing a computer to perform the processes of: in the case of generation of a playback request for playing back a content on any of the plurality of playback devices, determining whether the playback device requested to play back the content is able to playback the content; in the case where it is determined that the playback device is able to play back the content, causing the playback device to play back the content; in the case of generation of a handoff request to hand off playback process by the playback device playing back to other playback device, determining whether the other playback device is able to play back the content; and in the case where it is determined that the other playback device is able to play back the content, stopping the playback of the content and causing the other playback device to play back the content from a handoff position.

### Advantageous Effects of Invention

According to the present invention, it is possible to hand off a content under playback to another renderer without adding a new function to the renderer.

### BRIEF DESCRIPTION OF DRAWINGS

FIG. 1 is an explanatory diagram illustrating an example of the configuration of a home network in a first exemplary embodiment.

FIG. 2 is a sequence diagram illustrating an example of an operating sequence of a home network.

FIG. 3 is a sequence diagram illustrating an example of the operating sequence of a home network using UPnPAV.

FIG. 4 is an explanatory diagram illustrating an example of an operating environment where an HGW is not used.

FIG. 5 is an explanatory diagram illustrating an example of an operating environment where the HGW is used.

FIG. 6 is an explanatory diagram illustrating an example of web GUI displayed through an Internet browser of a user terminal.

FIG. 7 is an explanatory diagram illustrating an example of a display screen of a terminal equipped with the web GUI and a renderer.

FIG. 8 is an explanatory diagram illustrating an example of the configuration of a home network in the case where a server and a user terminal exist outside the home network.

FIG. 9 is a block diagram illustrating the main part of in-home equipment according to the present invention.

### DESCRIPTION OF EMBODIMENTS

### Exemplary Embodiment 1

Hereinafter, a first exemplary embodiment of the present invention will be described with reference to accompanying drawings.

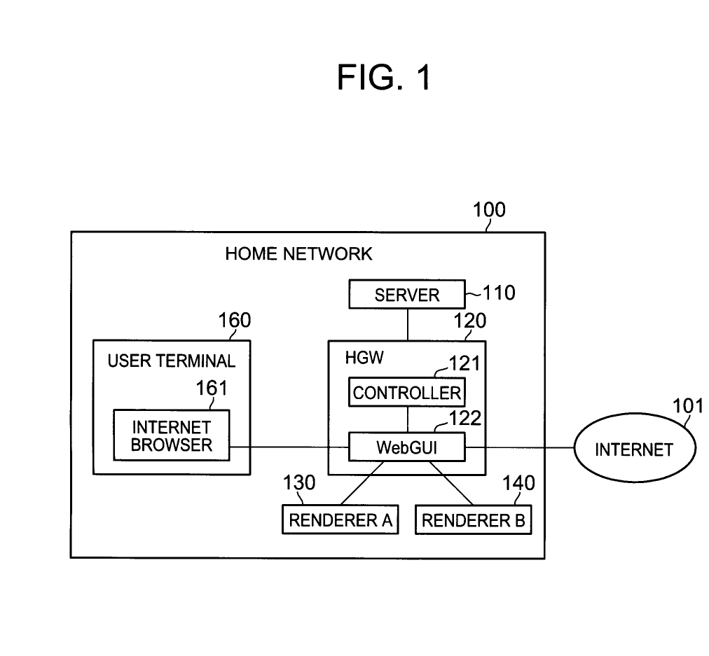

FIG. 1 is an explanatory diagram illustrating an example of the configuration of a home network according to a first exemplary embodiment.

As illustrated in FIG. 1, a home network 100 includes a server 110, a home gateway (HGW) 120, a renderer A 130, a renderer B 140, and a user terminal 160.

In this exemplary embodiment, the home network 100 is connected to the Internet 101 via the HGW 120. Moreover, the equipment connected to the home network 100 operates according to the DLNA (R) (digital living network alliance) or the UPnPAV (R) (universal plug and play AV). The DLNA is a set of technical guidelines for enabling content sharing between devices of different manufacturers in a home network. The DLNA defines a DMS (digital media server) which is a function of providing a content, a DMR (digital media renderer) related to a function of playing out a content, a DMC (digital media controller) related to a function of causing the DMR to play out a content, and the like. Further, the UPnPAV is a protocol by which the participation in the network is enabled only a connection of equipment and defines devices with various functions and a control point for controlling the devices. The devices in the UPnPAV are the DMS and the DMR and the control point is the DMC.

The serve 110 has the DMS function and stores contents including information such as a video and an image.

The renderer A 130 and the renderer B 140 each have the DMR function and play back contents.

The HGW 120 includes a controller 121 and a web graphical user interface (WebGUI) 122.

The controller 121 has the DMC function. The controller 121 searches for a content stored in the server 110 and displays the content on the renderer A 130 and the renderer B 140 by the DMC function according to the content of an instruction from the user terminal 160 which is received via the WebGUI 122.

The WebGUI 122 is a GUI operable via a web browser (hereinafter, referred to as the Internet browser). Moreover, the WebGUI 122 outputs the content of the operation of the GUI to the controller 121. Further, the WebGUI 122 acquires information on the renderers within the home network 100 from the controller 121 and provides a renderer selection screen in the GUI.

The controller 121 and the WebGUI 122 are able to be implemented by a microcomputer or the like which operates according to a program.

The user terminal 160 is able to use an Internet browser 161. The Internet browser 161 is a commonly-used Internet browser. Moreover, the user of the user terminal 160 operates the WebGUI 122 via the Internet browser 161 to instruct the controller 121 to perform or stop content playback or to switch renderers.

Subsequently, the operation of this exemplary embodiment will be described.

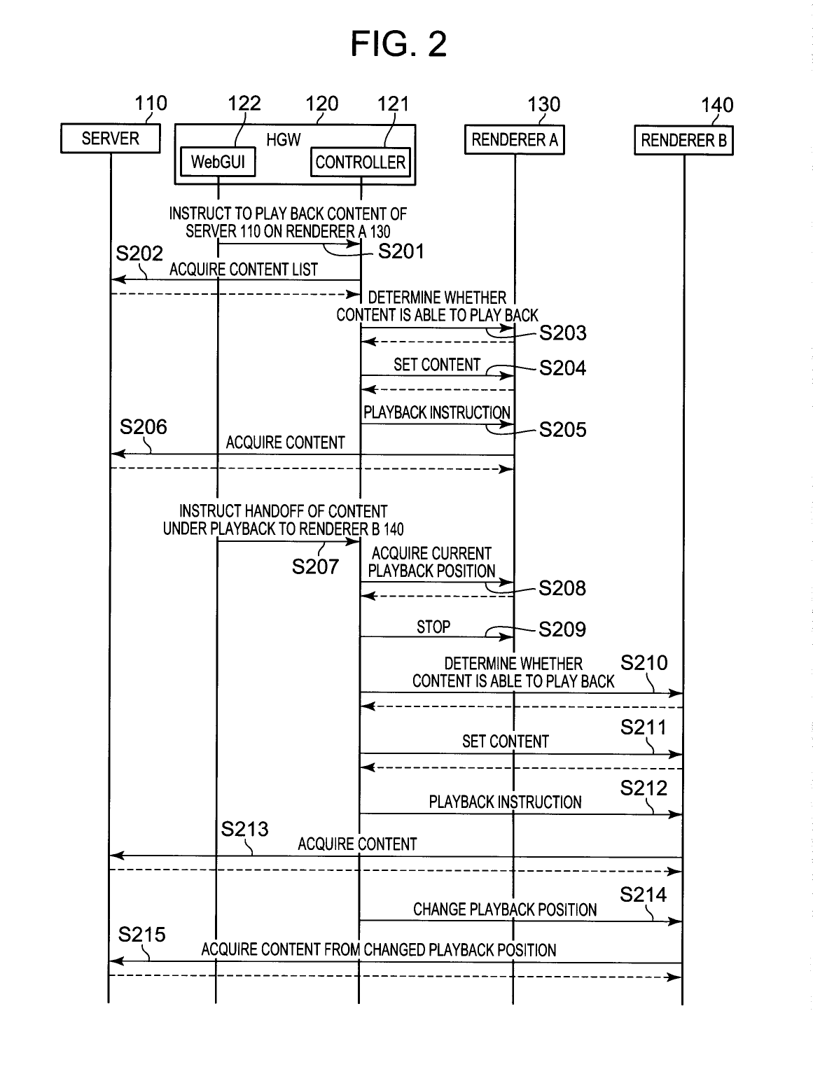

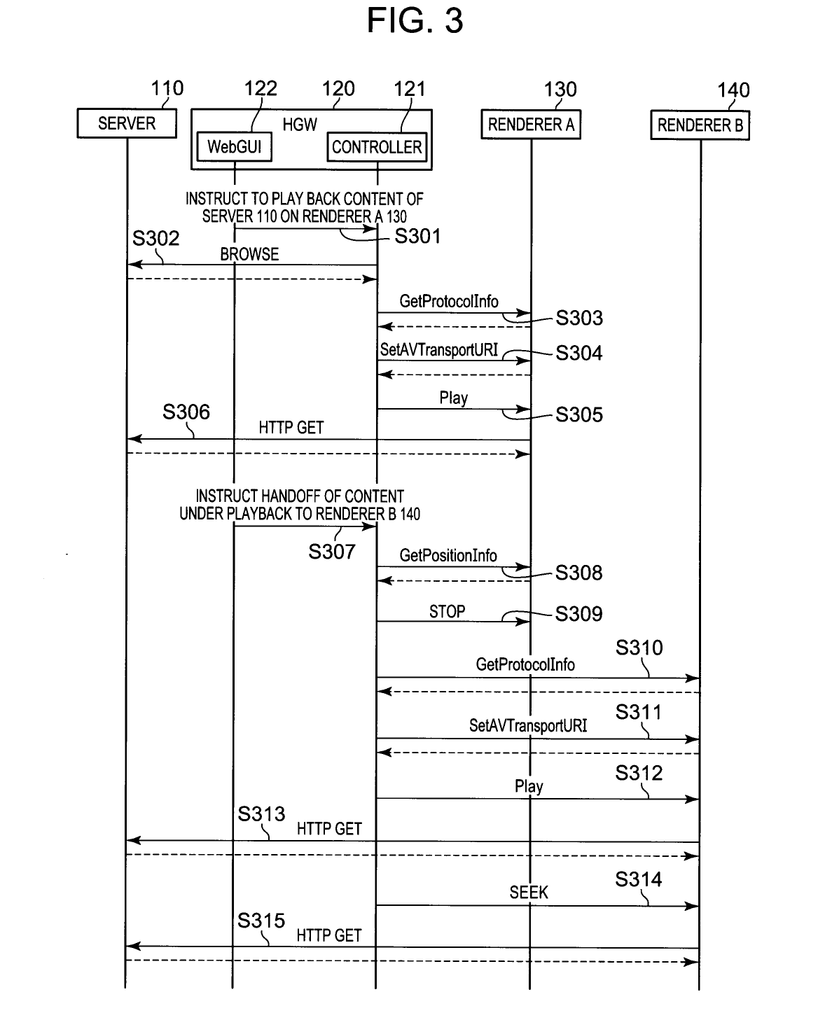

The operation of switching renderers in the home network 100 will be described with reference to FIGS. 2 and 3.

FIG. 2 is a sequence diagram illustrating an example of an operating sequence of the home network 100.

The user of the user terminal 160 operates the WebGUI 122 by using the Internet browser 161 to instruct the controller 121 to play back a content on the server 110 by the renderer A 130 (step S201).

Upon receiving the instruction, the controller 121 requests the server 110 to acquire a content list (step S202).

The controller 121 acquires playback environment information of the renderer A 130 and determines whether the renderer A 130 is able to play back the content on the basis of the playback environment information (step S203). The playback environment information represents the content playback ability of a renderer. The playback environment information includes, for example, the type of content which the renderer can play back and information on whether the renderer has a playback position change ability of the content.

If the renderer A 130 is able to play back the content, the controller 121 specifies the content for the renderer A 130 (step S204) and issues a playback instruction (step S205). The renderer A 130 acquires the content from the server 110 which retains the content and starts the playback (step S206).

If the user operates the WebGUI 122 to instruct the controller 121 to hand off the content playback from the renderer A 130 to the renderer B 140 while the renderer A 130 plays back the content (step S207), the controller 121 acquires the current playback position information from the renderer A 130 (step S208) and instructs the renderer A 130 to stop the playback (step S209). Upon receiving the playback stop instruction, the renderer A 130 stops the playback. The playback position information is time information or byte information representing a playback position.

The controller 121 acquires the playback environment information of the renderer B 140 and determines whether the renderer B 140 is able to play back the content on the basis of the playback environment information (step S210).

If the renderer B 140 is able to play back the content, the controller 121 specifies the content for the renderer B 140 (step S211) and issues a playback instruction (step S212). The renderer B 140 acquires the content from the server 110 which retains the content (step S213).

The controller 121 instructs the renderer B 140 to move the playback position to the position indicated by the playback position information acquired in the processing of step S208 (step S214). The renderer B 140 acquires the content from the playback position in the instruction of step S214 from the server 110 and starts the playback (step S215).

Referring to the sequence diagram of FIG. 3, the following description is made on the operation of the home network 100 in the case of using the UPnPAV.

The user of the user terminal 160 operates the WebGUI 122 by using the Internet browser 161 to instruct the controller 121 to play back the content on the server 110 by the renderer A 130 (step S301).

Upon receiving the instruction, the controller 121 sends a BROWSE message to the server 110 to request the server 110 to acquire a content list (step S302).

The controller 121 acquires playback environment information of the renderer A 130 by using a GetProtocolInfo message for the renderer A 130. The controller 121 determines whether the renderer A 130 is able to play back the content on the basis of the acquired playback environment information (step S303).

If the renderer A 130 is able to play back the content, the controller 121 specifies the content for the renderer A 130 by using a SetAVTransportURI message (step S304). Moreover, the controller 121 sends a Play message to give an instruction to start the playback (step S305). The renderer A 130 acquires the content from the server 110 which retains the content by using an HTTPGET message and starts the playback (step S306).

When the renderer A 130 is playing back the content, the user operates the WebGUI 122 to instruct the controller 121 to hand off the content playback from the renderer A 130 to the renderer B 140 (step S307).

The controller 121 acquires the current playback position information from the renderer A 130 by using a GetPositionInfo message (step S308). Moreover, the controller 121 sends a STOP message to the renderer A 130 to instruct the playback stop (step S309). Upon receiving the STOP message, the renderer 130 stops the playback.

The controller 121 acquires the playback environment information of the renderer B 140 by using the GetProtocolInfo message and determines whether the renderer B140 is able to play back the content on the basis of the playback environment information (step S310).

If the renderer B 140 is able to play back the content, the controller 121 specifies the content for the renderer B 140 by using a SetAVTransportURI message (step S311). Moreover, the controller 121 sends a Play message to give an instruction to start the playback (step S312). The renderer B 140 acquires the content from the server 110 which retains the content by using the HTTPGET message and starts the playback (step S313).

The controller 121 sends a SEEK message to the renderer B 140 to instruct the renderer B 140 to move the playback position to a position indicated by the playback position information which is acquired in step S308 (step S314). The renderer B 140 acquires the content from the playback position in the instruction in the processing of step S314 from the server 110 by using the HTTP GET message and starts the playback (step S315).

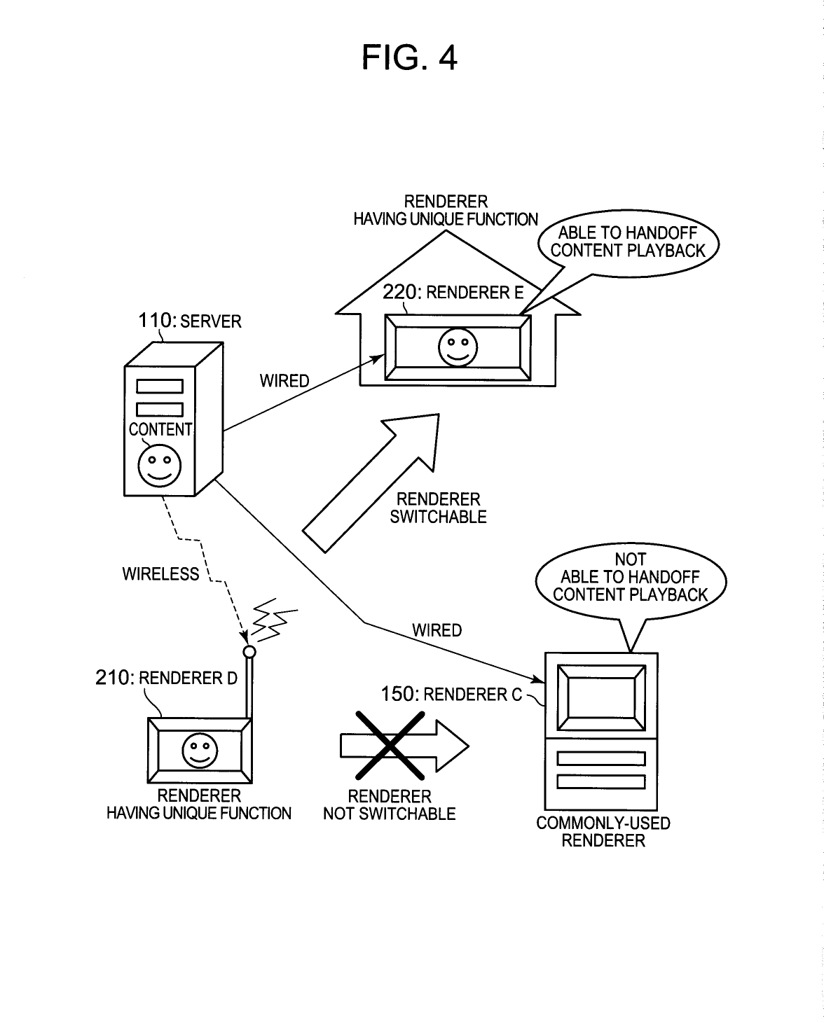

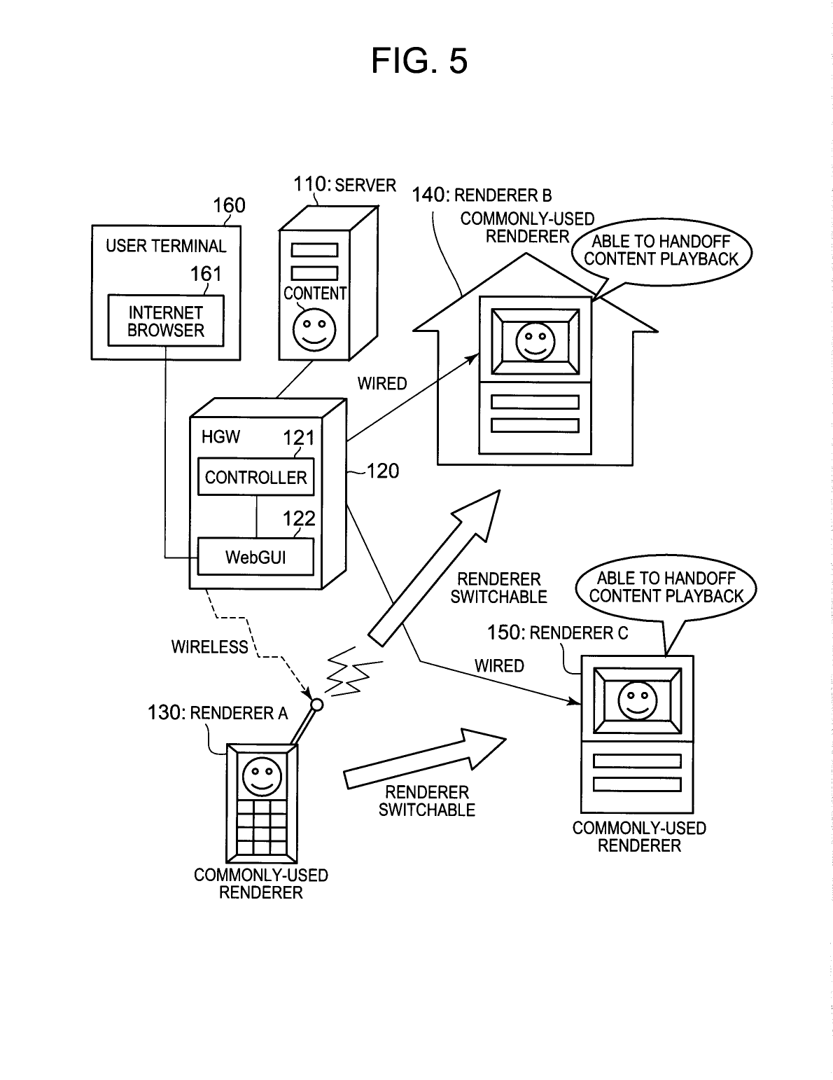

Referring to FIGS. 4 and 5, the outline of the operation of this exemplary embodiment will be described.

FIG. 4 is an explanatory diagram illustrating an example of an operating environment where the HGW 120 is not used. FIG. 5 is an explanatory diagram illustrating an example of an operating environment where the HGW 120 is used.

As illustrated in FIG. 4, in the case of not using the HGW 120 to which the present invention is applied, it is possible to switch the playback from a renderer D 210 having a unique function to a renderer E 220 having a unique function. It is, however, impossible to switch the playback to a renderer C 150 which is a commonly-used (not having a unique function) renderer.

As illustrated in FIG. 5, when using the HGW 120 of this exemplary embodiment, it is possible to switch the playback from the renderer A 130 having the DMR function to the renderer B 140 and the renderer C 150 each having the DMR function via the controller 121 provided in the HGW 120. Moreover, if the user terminal 160 has the Internet browser 161, which is a commonly-used Internet browser, the user of the user terminal 160 is able to operate the WebGUI 122 via the Internet browser 161.

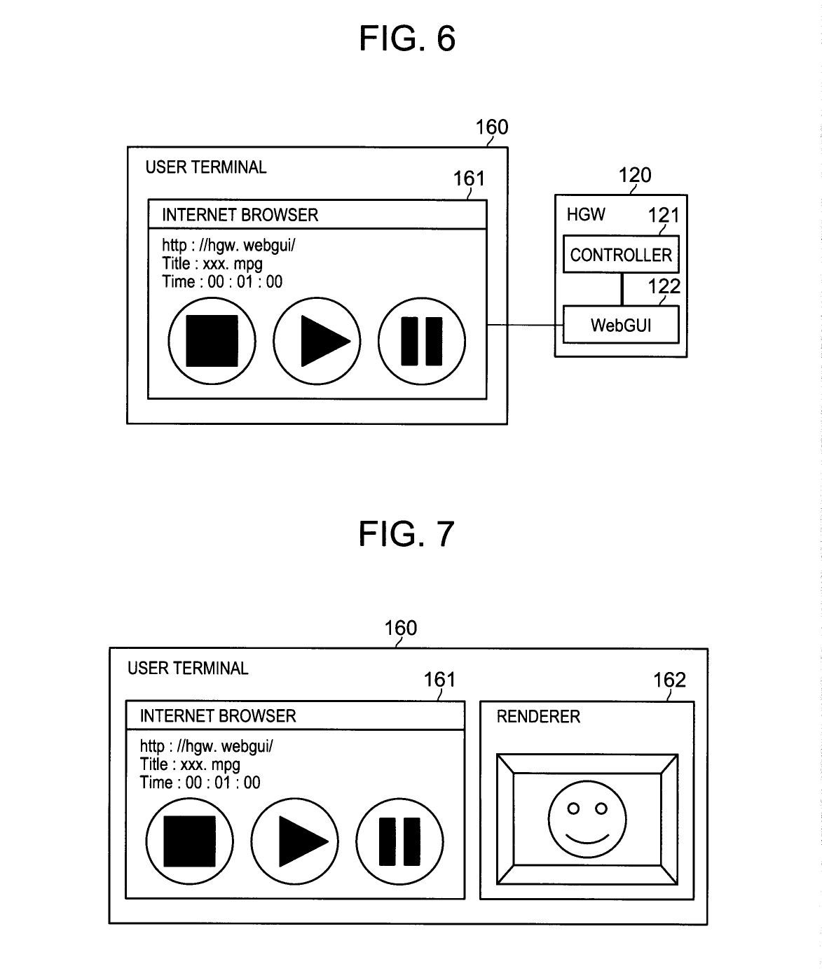

FIG. 6 is an explanatory diagram illustrating an example of the web GUI 122 displayed through the Internet browser 161 of the user terminal 160. As illustrated in FIG. 6, the user of the user terminal 160 is able to operate the interface of the WebGUI 122 in the same manner as a common DVD player.

As described in the above, there is no need to exchange information directly between renderers in this exemplary embodiment. Therefore, it is possible to hand off the content under playback to another renderer without adding a new function (a function other than the DMR function) to the renderer.

Moreover, the HGW 120 is able to be connected to a server or a renderer only with a function standardized by DLNA and UPnPAV. Therefore, the versatility of the system for implementing the handoff of the content under playback is high, thus enabling the system to be implemented at low cost. Moreover, in the system of this exemplary embodiment, a commercially-available DMS or DMR is able to be used.

Furthermore, the HGW is generally a constantly-energized device. Therefore, the user is able to use the HGW 120 seamlessly without concern for the turn-on or turn-off of the power supply of the HGW 120 independently of whether the user stays at home or goes out.

As illustrated in FIG. 7, the user terminal 160 which operates the WebGUI 122 may be equipped with the functions of a renderer 162 for playing back the content.

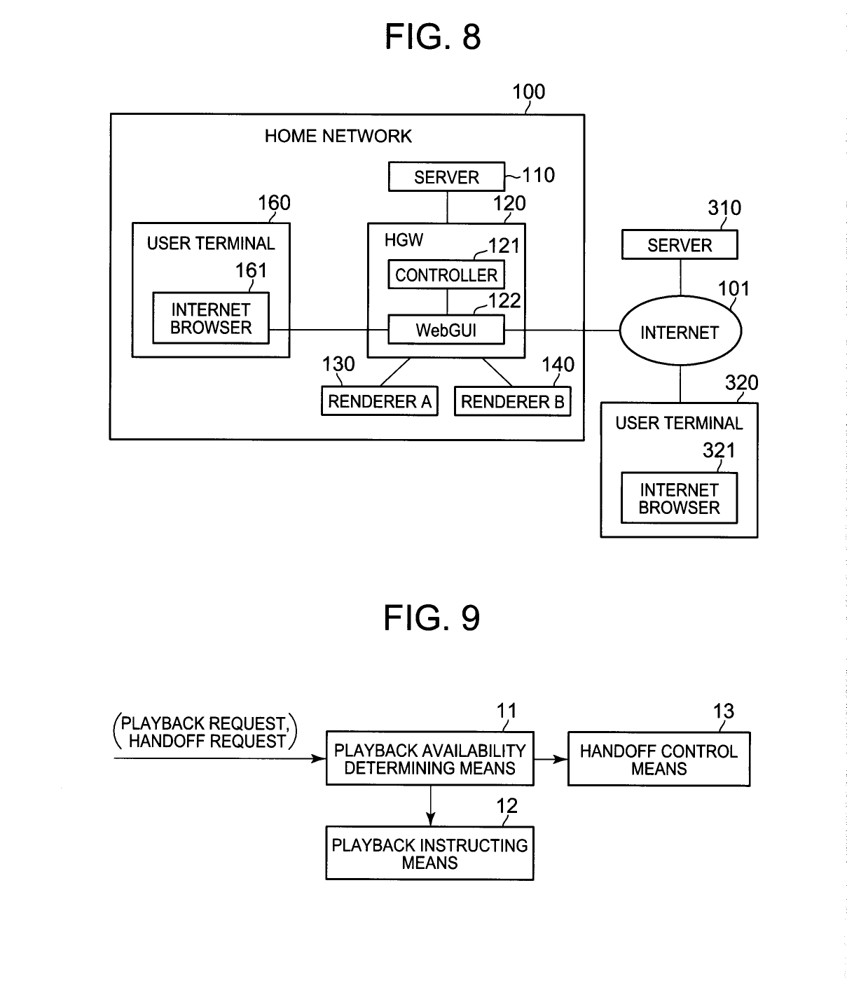

Moreover, the use of the filtering function of the HGW enables the use from an external network such as the Internet with the security maintained without a need for a particular operation. For example, as illustrated in FIG. 8, a user may operate the WebGUI 122 via a user terminal 320 connected to the outside of the home network 100 and the Internet 101. In such a case, the security is able to be ensured by the use of HTTPS or pre-authentication by the HGW 120 and the user terminal 320.

Moreover, it is possible to play back a content of a server 310 connected to the outside of the home network 100 via the Internet 101 as illustrated in FIG. 8.

Furthermore, the present invention is applicable even to a configuration in which the renderer A 130 and the renderer B 140 exist in the outside of the home network 100 and connected to the HGW 120 via the Internet 101. Moreover, the security is able to be ensured by the use of HTTPS or pre-authentication by the HGW 120 and the renderers existing outside the home network 100.

Although the HGW is taken as an example as the in-home equipment in this exemplary embodiment, the present invention is also applicable to the in-home equipment such as a broadband router.

FIG. 9 is a block diagram illustrating the main part of the in-home equipment according to the present invention.

As illustrated in FIG. 9, the in-home equipment (implemented by the HGW 120 in this exemplary embodiment) is connectable to one or a plurality of servers (implemented by the server 110 and the server 310 in the exemplary embodiment) and a plurality of playback devices (implemented by the renderer A 130, the renderer B 140, and the renderer C 150 in the exemplary embodiment). The in-home equipment includes: playback availability determining means 11 (implemented by the controller 121 in the exemplary embodiment) which, in the case of generation of a playback request for playing back a content on one of the plurality of playback devices, determines whether the playback device requested to play back the content is able to play back the content; and playback instructing means 12 (implemented by the controller 121 in the exemplary embodiment) which, in the case where the playback availability determining means 11 determines that the playback device is able to play back the content, causes the playback device to play back the content. In the case of generation of a handoff request which requests that playback processing by the playback device currently playing back the content be handed off by some other playback device, the playback availability determining means 11 determines whether the other playback device is able to play back the content, and the in-home equipment further includes handoff control means 13 (implemented by the controller 121 in the exemplary embodiment) which stops the playback of the content and causes the other playback device to play back the content from a handoff position in the case where the playback availability determining means 11 determines that the other playback device is able to play back the content.

The above exemplary embodiment also discloses the following types of in-home equipment.

(1) An in-home equipment which includes operation means (implemented by the WebGUI 122 in the exemplary embodiment) having GUI wherein the operation means generates a handoff request on the basis of a fact that a user has performed an operation through the GUI
(2) An in-home equipment wherein the GUI uses a web browser
(3) An in-home equipment wherein the playback instructing means 12 and the handoff control means 13 are implemented by DMC functions based on a DLNA standard
(4) An in-home equipment which is a home gateway or a broadband router

Although the present invention has been described with reference to the exemplary embodiment and examples hereinabove, the present invention is not limited thereto. A variety of modifications, which can be understood by those skilled in the art, may be made in the configuration and details of the present invention within the scope thereof.

This application claims priority to Japanese Patent Application No. 2010-283488 filed on Dec. 20, 2010, and the entire disclosure thereof is hereby incorporated herein by reference.

### REFERENCE SIGNS LIST

1 playback availability determining means
12 playback instructing means
13 handoff control means
100 home network
101 internet
110, 310 server
120 HGW
121 controller
122 WebGUI
130 renderer A
140 renderer B
150 renderer C
160, 320 user terminal
161, 321 internet browser
162 renderer
210 renderer D
220 renderer E

1. An in-home equipment which is connectable to one or a plurality of servers and a plurality of playback devices, comprising:
a playback availability determining unit which, in the case of generation of a playback request for playing back a content on any of the plurality of playback devices, determines whether the playback device requested to playback the content is able to play back the content; and
a playback instructing unit which, in the case where the playback availability determining unit determines that the playback device is able to play back the content, causes the playback device to play back the content,
wherein, in the case of generation of a handoff request to hand off playback process by the playback device playing back the content to other playback device, the playback availability determining unit determines whether the other playback device is able to play back the content, and
wherein the in-home equipment further comprises a handoff control unit which stops the playback of the content and causes the other playback device to play back the content from a handoff position in the case where the playback availability determining unit determines that the other playback device is able to play back the content.

2. The in-home equipment according to claim 1, further comprising an operation unit having GUI,
wherein the operation unit generates a handoff request on the basis of a fact that a user has performed an operation through the GUI.

3. The in-home equipment according to claim 2, wherein the GUI uses a web browser.

4. The in-home equipment according to claim 1, wherein the playback instructing unit and the handoff control unit are implemented by DMC functions based on a DLNA standard.

5. The in-home equipment according to claim 1, which is a home gateway or a broadband router.

6. A content handoff method in an in-home equipment which is connectable to one or a plurality of servers and a plurality of playback devices, comprising the steps of:
in the case of generation of a playback request for playing back a content on any of the plurality of playback devices, determining whether the playback device requested to playback the content is able to play back the content;
in the case where it is determined that the playback device is able to play back the content, causing the playback device to play back the content;
in the case of generation of a handoff request to hand off playback process by the playback device playing back to other playback device, determining whether the other playback device is able to play back the content; and
in the case where it is determined that the other playback device is able to play back the content, stopping the playback of the content and causing the other playback device to play back the content from a handoff position.

7. A non-transitory computer readable information recording medium storing a content handoff program which, when executed by a processor, performs a method for:
in the case of generation of a playback request for playing back a content on any of a plurality of playback devices, determining whether the playback device requested to play back the content is able to playback the content;
in the case where it is determined that the playback device is able to play back the content, causing the playback device to play back the content;
in the case of generation of a handoff request to hand off playback process by the playback device playing back to other playback device, determining whether the other playback device is able to play back the content; and
in the case where it is determined that the other playback device is able to play back the content, stopping the playback of the content and causing the other playback device to play back the content from a handoff position.
